(19) United States
(12) Patent Application Publication
(10) Pub. No.: US 2018/0001849 A1
(43) Pub. Date: Jan. 4, 2018

(54) WIRE HARNESS

(71) Applicant: Yazaki Corporation, Tokyo (JP)

(72) Inventors: Kimihiro ABE, Makinohara-shi (JP); Hideomi ADACHI, Makinohara-shi (JP); Masahide TSURU, Makinohara-shi (JP); Takeshi OGUE, Makinohara-shi (JP); Hiroyuki YOSHIDA, Makinohara-shi (JP); Kenta YANAZAWA, Makinohara-shi (JP); Toshihiro NAGASHIMA, Makinohara-shi (JP); Tetsuo YAMADA, Makinohara-shi (JP); Youji INAGAWA, Toyota-shi (JP); Shigeru TANAKA, Kakegawa-shi (JP); Takayoshi HIRAKAWA, Kakegawa-shi (JP); Yasuhiro TANAKA, Kakegawa-shi (JP)

(73) Assignee: Yazaki Corporation, Tokyo (JP)

(21) Appl. No.: 15/636,940

(22) Filed: Jun. 29, 2017

(30) Foreign Application Priority Data
Jun. 30, 2016 (JP) 2016-129668

(51) Int. Cl. B60R 16/02; B60R 16/023

(52) U.S. Cl. CPC B60R 16/0215; B60R 16/023

(57) ABSTRACT

A wire harness includes a conductive path for electrically connecting devices to each other and a function enhancement part, in which one or multiple locations of an intermediate portion of the conductive path are disconnected, and disconnected portions of the conductive path are electrically connected to each other to enhance a function. The function enhancement part, in a state before the function is enhanced, is formed in a structure part in which a male connector provided on one end of a disconnected position of the conductive path and a female connector provided on the other end of the disconnected positions of the conductive path are connected together. The function enhancement part, in a state that the function is enhanced, is formed in a structure part in which one or multiple function enhancement part main bodies are arranged between the male connector and the female connector.

### CROSS REFERENCE TO RELATED APPLICATIONS

This application claims priority from Japanese Patent Application No. 2016-129668 filed on Jun. 30, 2016, the entire contents of which are incorporated herein by reference.

### BACKGROUND OF THE INVENTION

### Field of the Invention

The invention relates to a wire harness which includes a conductive path and connects together devices electrically.

### Description of Related Art

As a conventional wire harness for electrically connecting together high voltage devices (auxiliary devices) mounted on a hybrid car or an electric car, there is known a wire harness disclosed in, for example, the below cited patent document 1: JP-A-2014-42443. The wire harness includes one or multiple conductive paths, an exterior member for storing and protecting the conductive path(s), an external connecting member arranged in the terminal of the wire harness for connecting the wire harness to an external high voltage device, and multiple fixing members for installing and fixing the wire harness to a fixing target.

### [Patent Document 1] JP-A-2014-42443

According to a related art, devices (auxiliary devices) to which a wire harness is to be connected are an inverter unit provided in an engine room of a car and a battery provided in a rear part of a car. Meanwhile, a wire harness to be electrically is wished to be connected further to another device (auxiliary device) in addition to the above two devices. However, when enhancing the conductive path from the engine room side harness terminal of the wire harness to another device in the above structure, since the wire harness is wired as if the conductive path is U-turned, there is raised a problem that the wiring operation is complicated. Also, it is not necessarily the shortest to enhance the conductive path from the harness terminal to another device but the conductive path becomes longer by the U turn, thereby raising a problem that the cost is expensive. Further, when trying to additionally connect a new device different from the above, there is further raised a problem that such additional connection is difficult.

### SUMMARY

One or more embodiments provide a wire harness which can realize connection of another device and additional connection of a device afterward.

A wire harness includes a conductive path for electrically connecting devices to each other and a function enhancement part, in which one or multiple locations of an intermediate portion of the conductive path are disconnected, and disconnected portions of the conductive path are electrically connected to each other so as to enhance a function. The function enhancement part, in a state before the function is enhanced, is formed in a structure part in which a male connector provided on one end of a disconnected position of the conductive path and a female connector provided on the other end of the disconnected positions of the conductive path are connected together. The function enhancement part, in a state that the function is enhanced, is formed in a structure part in which one or multiple function enhancement part main bodies are arranged between the male connector and the female connector. The function enhancement part main body includes a function-enhancement-part-side female connector connectable to the male connector, a function-enhancement-part-side male connector connectable to the female connector, a connectors connecting circuit which connects together the function-enhancement-part-side female connector and the function-enhancement-part-side male connector, and a branch connecting circuit to be connected to the connectors connecting circuit. The function-enhancement-part-side female connector and the function-enhancement-part-side male connector of the function enhancement part main bodies which are adjacent, are connectable to each other.

According to one or more embodiments, in the wire harness electrically connecting together the devices, when trying to connect a further device different from the above devices to the wire harness, or when trying to connect a still further device newly and additionally afterward to the wire harness, there are used the function enhancement part formed in the intermediate portion of the conductive path of the wire harness. When connector connection between the male and female connectors in the conductive path is removed and one or multiple function enhancement part main bodies are provided between the male and female connectors, the function enhancement part is enabled to connect a further device. Here, when connection of a further device is not necessary, the connector connection between the male and female connectors may be left intact.

In one or more embodiments, the term “connector” means an electric connection member. Thus, various electric connection members are available: that is, “male connector” and “female connector” may be read as “first connector” or “first electric connection member”, and “second connector” or “second electric connection member”.

In the wire harness, an overcurrent blocking part which blocks an overcurrent may be provided in the branch connecting circuit.

According to one or more embodiments, when enhancing the function, it is possible to prevent an overcurrent from flowing into the above-mentioned further device.

In the wire harness, the function enhancement part main body may include a case body in which the connectors connecting circuit and the overcurrent blocking part are stored. The overcurrent blocking part may be drawn out to outside from the case body, and the case body may include a cover part facing the connectors connecting circuit and the overcurrent blocking part.

According to one or more embodiments, the connectors connecting circuit and overcurrent blocking part can be protected by the case body. Also, formation of the cover part in the case body enables replacement of the overcurrent blocking part.

In the wire harness, when a plurality of the function enhancement part main body are arranged in the function enhancement part, the branch connecting circuit may be drawn out in two different directions with respect to the length direction of the conductive path.

According to one or more embodiments, the above-mentioned further devices can be connected in two different directions with respect to the length direction of the conductive path. This enables, for example, enhancement of workability related to connection and prevention of misconnection.

In the wire harness, the function enhancement part main body may include a fixing part which fixes the wire harness to a fixing target of a wiring destination.

According to one or more embodiments, when wiring the wire harness, the wire harness can be fixed at the position of the function enhancement part. Also, at the position of the function enhancement part, the wire harness can be fixed without using an exclusive fixing part.

Here, it is conceivable to fix the wire harness using a known protector but, in this case, if the protector covers the function enhancement part, replacement of the overcurrent blocking part is difficult. This shows that the above one or more embodiments are useful when compared with the protector.

In the wire harness, the function enhancement part may include a structure part having a shield function or a waterproof function.

According to one or more embodiments, it is possible to secure shielding property and waterproofness in a location where the function enhancement part is formed.

In the wire harness, the conductive path may include any one or a combination of a conductive path having a stranded conductor, a conductive path having a bar conductor, a conductive path having a bus bar, and a conductive path with multiple conductors and insulators arranged coaxially. The combination may include different type conductive paths which are different at least before and behind the function enhancement part.

According to one or more embodiments, it is possible to use various types of conductive paths. For example, when two function enhancement parts are present and the interval between them is wide, there may be used a highly rigid conductive path, that is, a conductive path including a bar conductor or a bus bar. This can effectively facilitate the retention of the route. Also, when bending is necessary, a conductive path including a stranded conductor may be used. Further, to reduce the wiring space of the wire harness, there may be used a conductive path including multiple coaxially arranged conductors and insulators.

One or more embodiments may preferably be applied to a long wire harness which is wired, for example, through the vehicle underfloor.

According to one or more embodiments, since one or multiple locations of the intermediate portion of the conductive path are disconnected to form the function enhancement parts capable of enhancing function by electric connection, there is provided an effect that, using the function enhancement parts, a further device (device) can be connected to the wire harness and a still further device can be newly and additionally connected to the wire harness afterwards. Also, according to one or more embodiments, when trying to connect a further device, or when trying to connect a still further device newly and additionally afterward, the conductive path need not be set in a state as if it is U turned from the position of the harness terminal. Thus, there is provided an effect that the wire harness can be provided using a conductive path having a minimum required length. This also provides an effect that, with respect to connection to a further device, workability can be enhanced and the cost can be thereby reduced.

According to one or more embodiments, since the overcurrent blocking portion is formed in the function enhancement part, there is provided an effect that an overcurrent can be prevented from flowing into the above-mentioned further device.

According to one or more embodiments, there is provided an effect that, since the case body is formed in the function enhancement part, the connectors connecting circuit and overcurrent blocking portion can be protected. Also, since the cover portion is formed in the case body, there is provided an effect that the overcurrent blocking portion can be replaced simply by opening the cover portion.

According to one or more embodiments, there is provided an effect that, since, when multiple function enhancement parts are present, the branch connecting circuit is pulled out in different directions, for example, workability related to connection can be enhanced and misconnection can be prevented.

According to one or more embodiments, there is provided an effect that, since the fixing portion is formed in the function enhancement part, when wiring the wire harness, it can be fixed without an exclusive fixing part. According to one or more embodiments, there is further provided an effect that it can contribute to cost reduction and workability enhancement.

According to one or more embodiments, there is provided an effect that, since the function enhancement part has shield function and/or waterproof function, shielding property and waterproofness can be secured in the location where the function enhancement part is formed.

According to one or more embodiments, there is provided an effect that various types of conductive paths can be used. Also, there are further provided an effect that, before and behind the function enhancement part, different types of conductive paths can be used. Also, an effect that the optimum type of conductive path can be used according to the wiring location of the wire harness.

### BRIEF DESCRIPTION OF THE DRAWINGS

FIG. 1 is a schematic view of the wired state of a wire harness and the state thereof before the function thereof is enhanced.

FIG. 2 is a schematic view of the wired state of the wire harness and the state thereof after the function thereof is enhanced (one auxiliary device).

FIG. 3 is a schematic view of the wired state of the wire harness and the state thereof after the function thereof is enhanced (two auxiliary devices).

FIGS. 4A, 4B, and 4C show the configuration of a conductive path. FIG. 4A is a view of a conductive path including a stranded conductor or a bar conductor, FIG. 4B is a view a conductive path including a bus bar, and FIG. 4C is a view of a conductor including multiple conductors and insulators arranged coaxially.

FIGS. 5A and 5B show a male connector and a female connector in the function enhancement part. FIG. 5A is a view of the male and female connectors, showing a state where they are connector fitted with each other, and FIG. 5B is a view of the male and female connectors, showing a state where they are electrically connected to each other.

FIGS. 6A and 6B show the male connector and female connector in the function enhancement part. FIG. 6A is a view of a state where the connector fitting between them is removed, and FIG. 6B is a view of a state where the electric connection between them is removed.

FIG. 7 is a view of a function enhancement part main body.

FIG. 8 is a view of a circuit configuration of the function enhancement part main body.

FIG. 9 is a view of the function enhancement part main body, showing a state where a cover part is removed therefrom.

FIG. 10 is a view of a state where a function enhancement part main body is formed between the male and female connectors to form a function enhancement part.

FIG. 11 is a view of the electrically connected state of FIG. 10.

FIG. 12 is a view of a state where two function enhancement part main bodies are formed between the male and female connectors to form a function enhancement part.

FIG. 13 is a view of a modification of the function enhancement part main body.

FIG. 14 is a view of a modification for providing a shield function.

### DETAILED DESCRIPTION

A wire harness includes a conductive path and is used to electrically connect together devices, while, in one or multiple locations of the intermediate portion of the conductive path, there are formed one or multiple function enhancement parts. The function enhancement parts are formed in structure parts where the locations of the intermediate portion of the conductive path are disconnected to enhance a function through electric connection. In a state before the function is enhanced, the function enhancement parts are formed in the structure parts that are connected together by a male connector disposed in one end of the conductive path and a female connector disposed in the other end of the conductive path in the disconnected locations. Also, at the time when enhancing the function, the function enhancement parts are formed in structure parts where one or multiple function enhancement part main bodies are present between the male and female connectors.

In each function enhancement part main body, there are formed a function-enhancement-part-side female connector, a function-enhancement-part-side male connector, a connectors connecting circuit and a branch connecting circuit. Further, in order that multiple function enhancement part main bodies can exist, the function-enhancement-part-side female connector and function-enhancement-part-side male connector of the adjoining function enhancement part main bodies are formed to be connectable to each other.

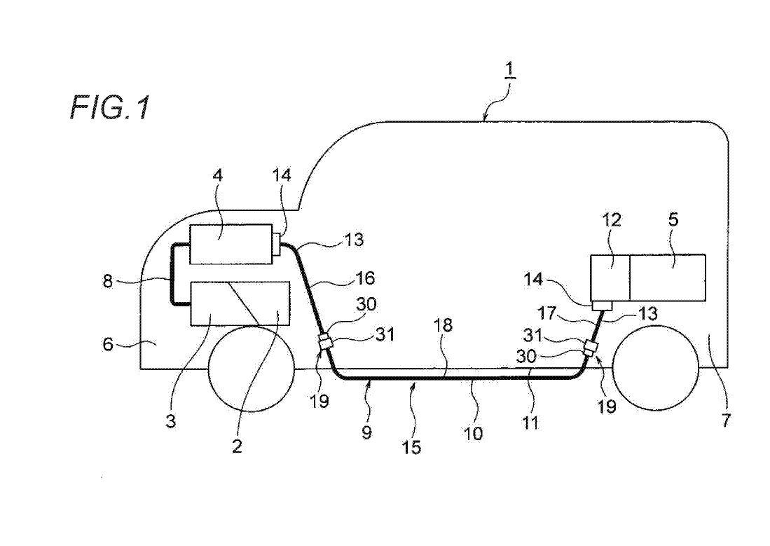

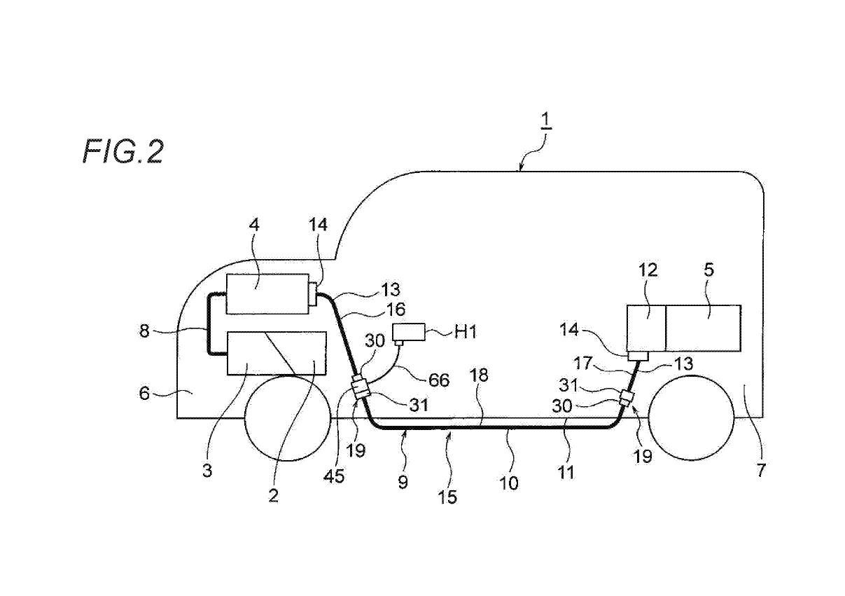

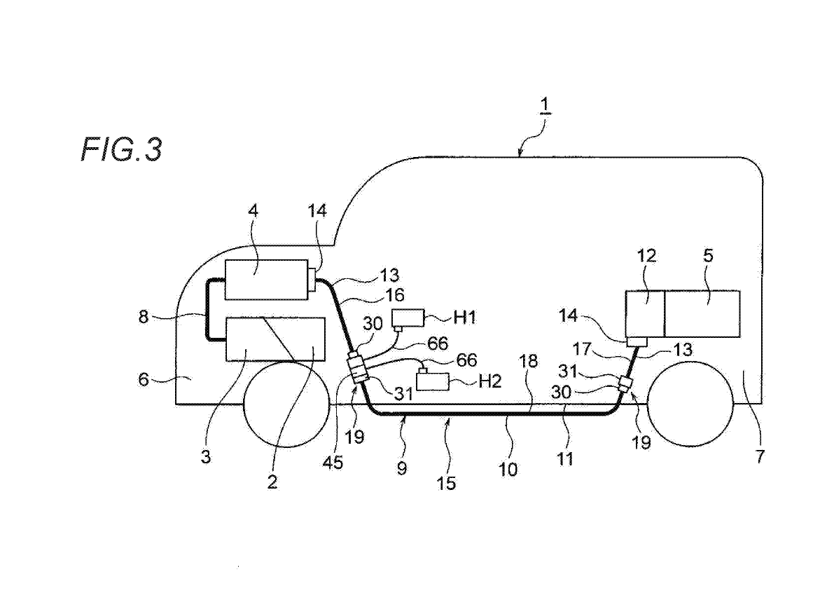

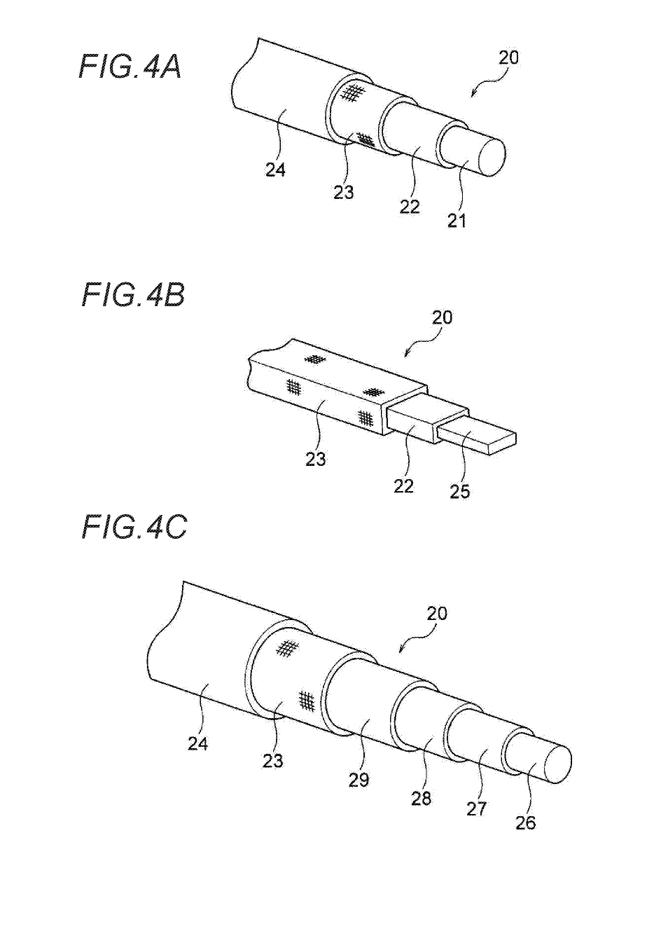

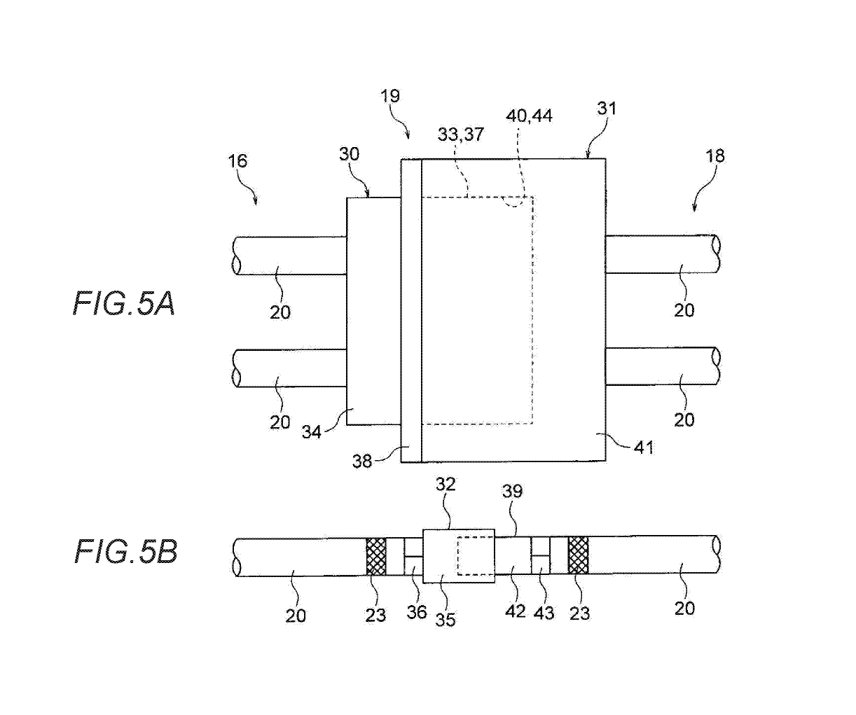

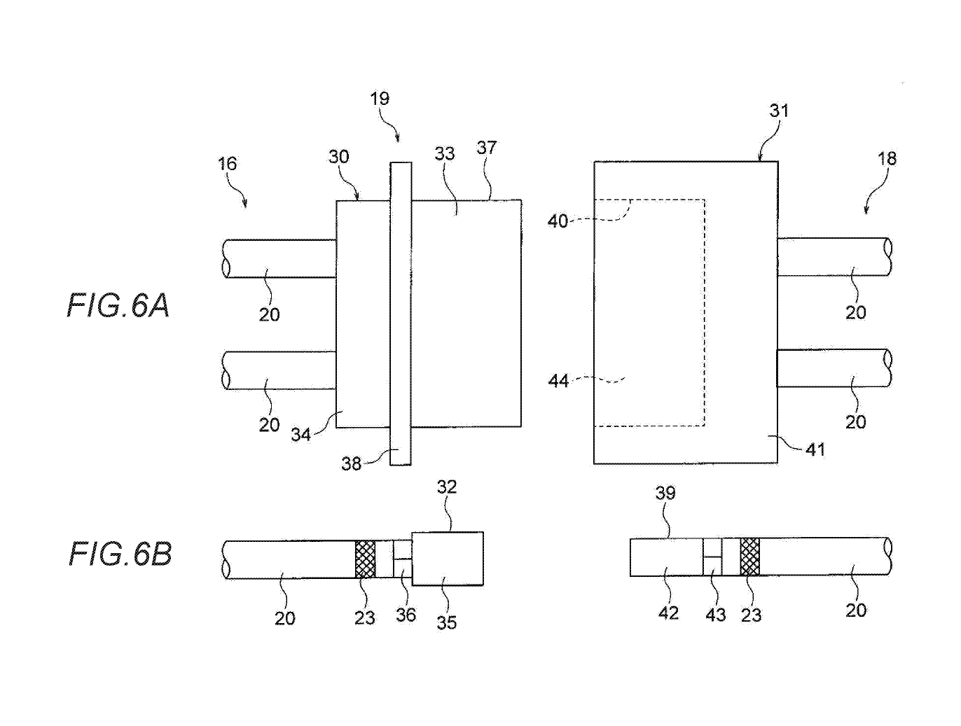

FIG. 1 is a schematic view of the wired state of a wire harness and the state thereof before the function is enhanced. FIGS. 2 and 3 are schematic views of the state of the wire harness after the function is enhanced. FIGS. 4A, 4B, and 4C shows the structure of a conductive path, FIGS. 5A and 5B show a male connector and a female connector in the function enhancement part, and FIGS. 6A and 6B show the male and female connectors in the function enhancement part.

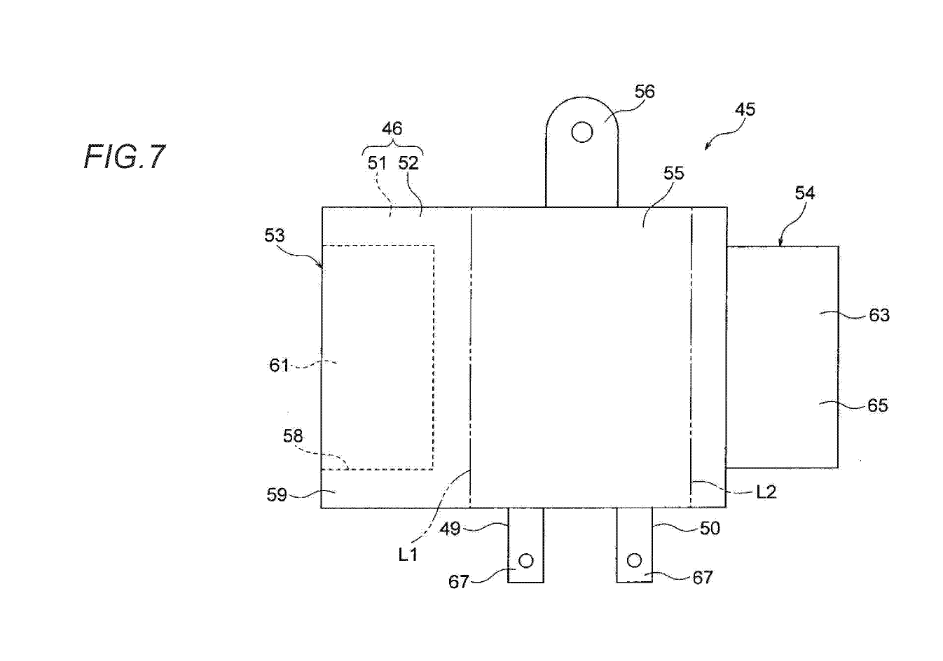

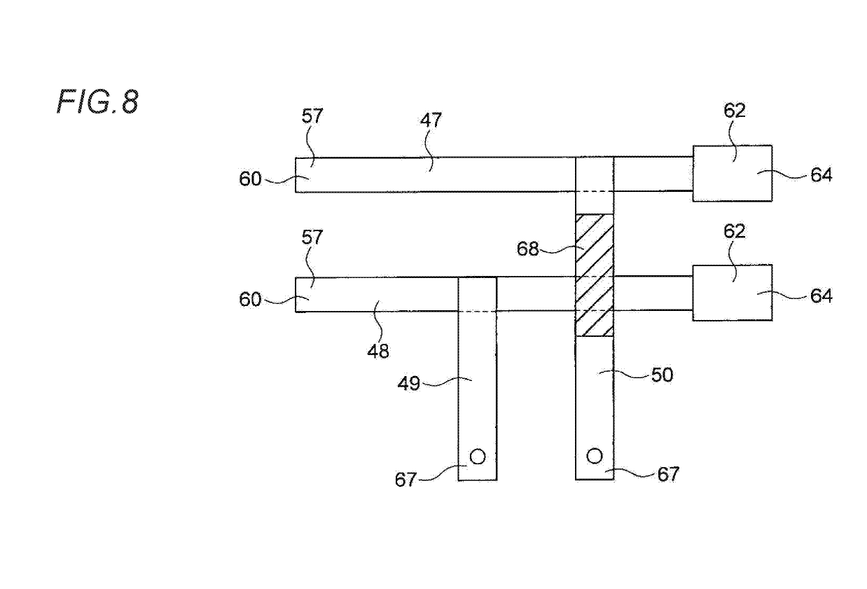

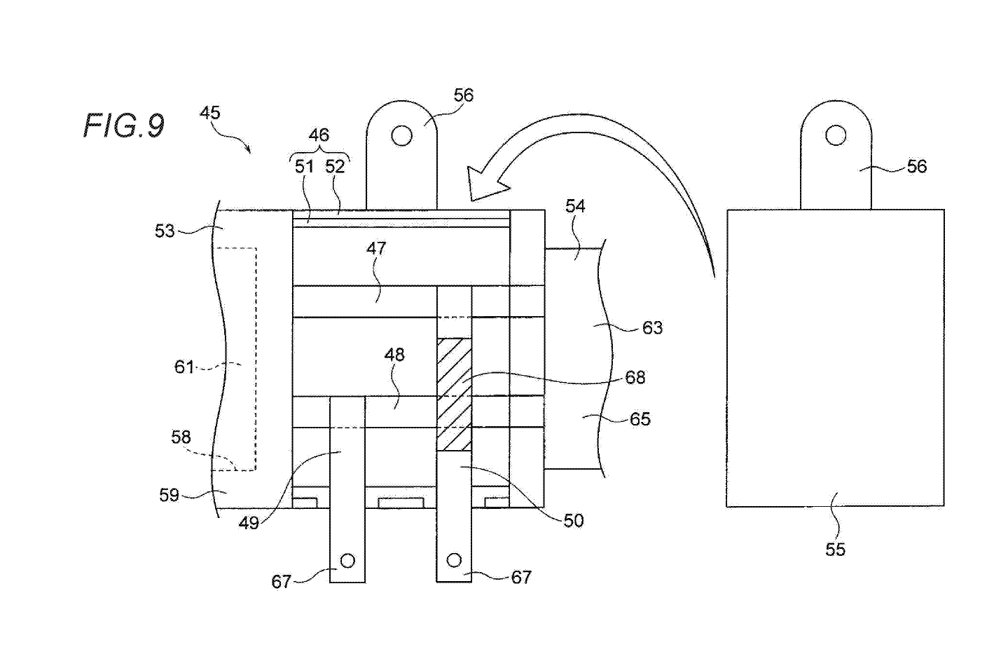

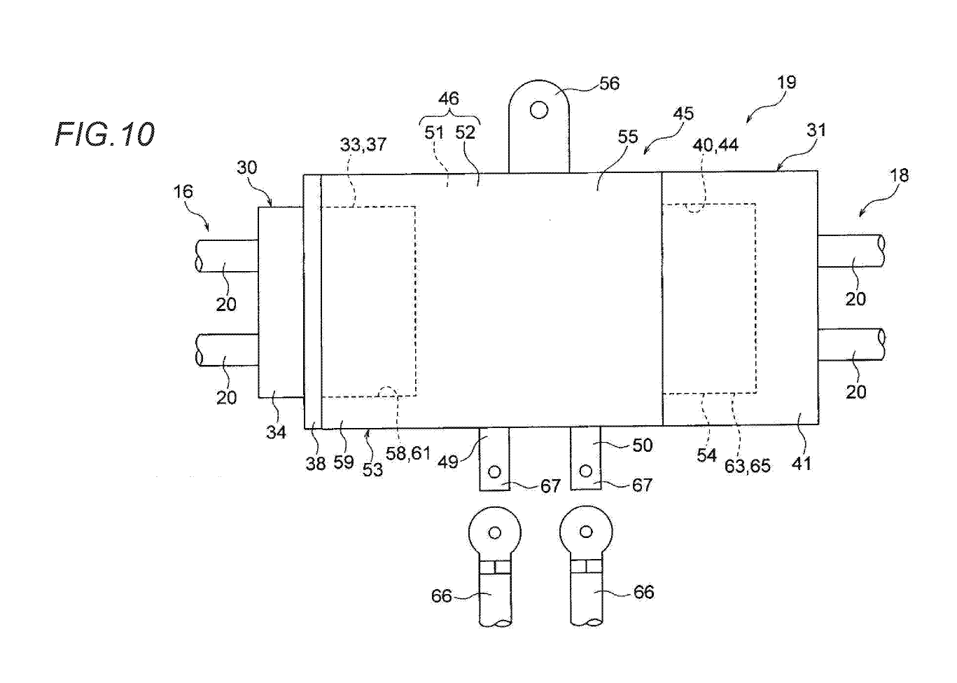

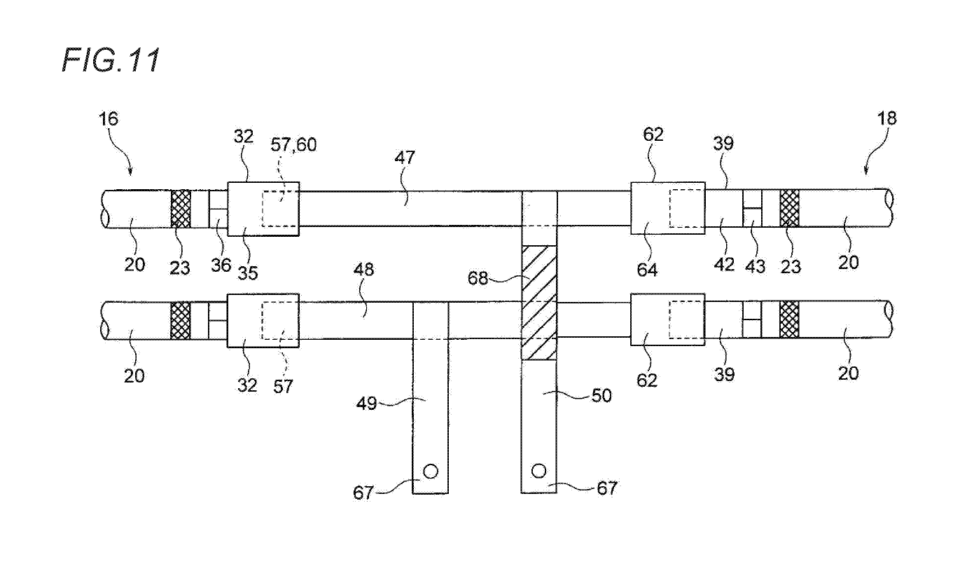

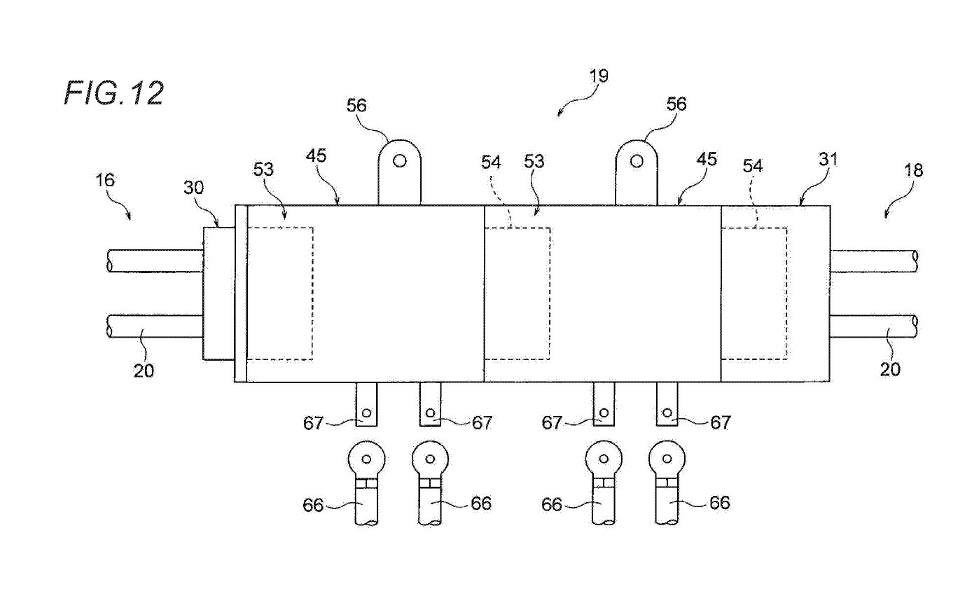

Also, FIG. 7 is a view of a function enhancement part main body, FIG. 8 is a view of a circuit configuration of the function enhancement part main body, and FIG. 9 is a view of the function enhancement part main body, with a cover part removed therefrom. FIG. 10 is a view of a state where a function enhancement part main body is formed between the male and female connectors to form a function enhancement part, FIG. 11 is a view of the electrically connected state of FIG. 10, and FIG. 12 is a view of a state where two function enhancement part main bodies are formed between the male and female connectors to form a function enhancement part.

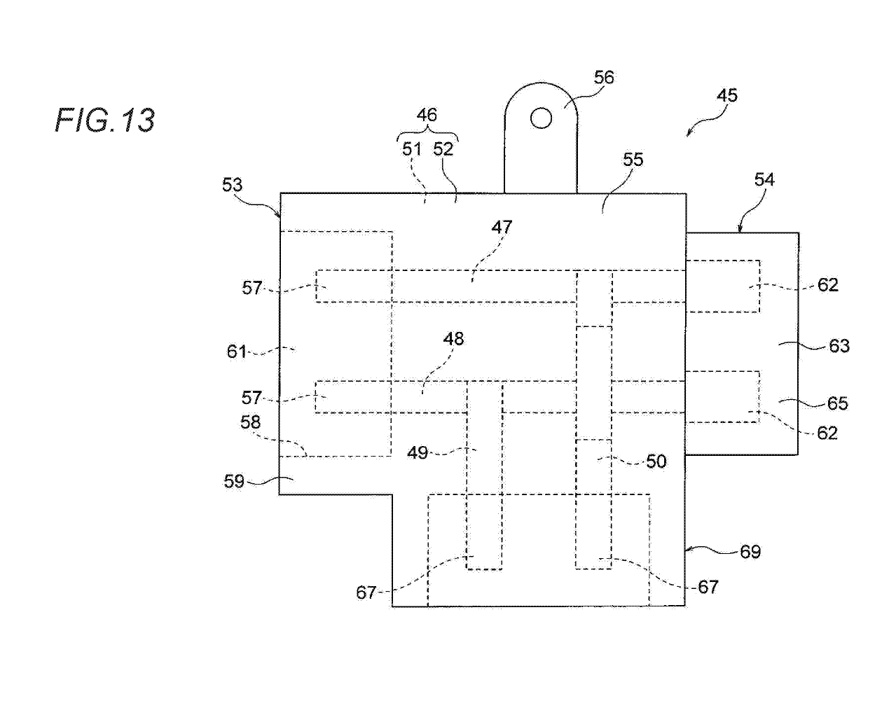

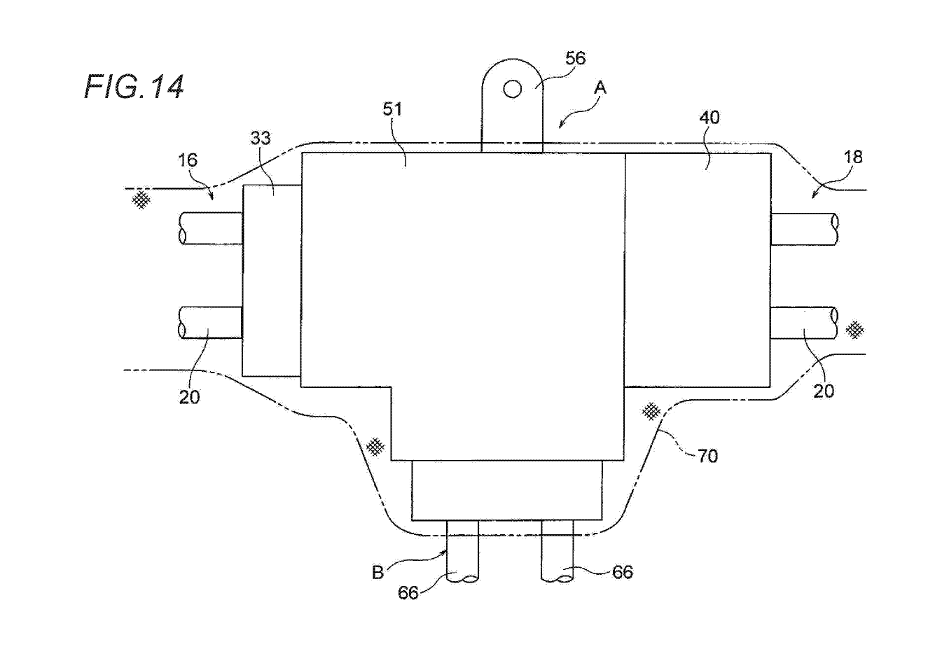

Also, FIG. 13 is a view of a modification of the function enhancement part main body, and FIG. 14 is a view of a modification for providing a shield function.

This embodiment is applied to a wire harness to be wired in a hybrid car (which may also be an electric car or the like).

### <Hybrid Car 1>

In FIGS. 1 to 3, reference numeral 1 designates a hybrid car. The hybrid car 1 is a vehicle which is driven by mixing two kinds of power respectively supplied from an engine 2 and a motor unit 3, while power from a battery 5 (battery pack) is supplied to the motor unit 3 through an inverter unit 4 (device). The engine 2, motor unit 3 and inverter unit 4, in this embodiment, are mounted in an engine room 6 where front wheels etc. are located. Also, the battery 5 is mounted in a car rear part 7 where rear wheels etc. are located (it may also be mounted within a car room existing backward of the engine room 6).

The motor unit 3 and inverter unit 4 are connected together by a high pressure (a high voltage) wire harness 8. Also, the battery 5 and inverter unit 4 are also connected by a high pressure wire harness 9. The intermediate part 10 of the wire harness 9 is wired in a vehicle underfloor 11 and is wired along the vehicle underfloor 11 substantially in parallel thereto. The vehicle underfloor 11 is a well-known body and is a so called panel member, while a penetration hole is formed at a given position thereof. The wire harness 9 is watertight inserted into this penetration hole.

The wire harness 9 and battery 5 are connected together through a junction block 12 (device) provided in the battery 5. To the junction block 12, there is electrically connected an external connecting member such as a shield connector 14 arranged in a harness terminal 13 provided on the rear end side of the wire harness 9. Also, the wire harness 9 and inverter unit 4 are electrically connected together through an external connecting member such as a shield connector 14 arranged in a harness terminal 13 provided on the front end side of the wire harness 9.

The motor unit 3 is constituted of a motor and a generator. Also, the inverter unit 4 is constituted of an inverter and a converter. The motor unit 3 is formed as a motor assembly including a shield case. The inverter unit 4 is also formed as an inverter assembly including a shield case. The battery 5 is a Ni-MH system or Li-ion system battery produced by modularization. Here, it is also possible to use a power storage device such as a capacitor. The battery 5, of course, is not limited particularly but other device may also be used so long as it can be used in the hybrid car 1 or an electric car.

### <Wire Harness 9>

In FIGS. 1 to 3, a long-sized wire harness 9 to be wired through the vehicle underfloor 11 is constituted of a harness main body 15 and two shield connectors 14 respectively arranged in the two ends of the harness main body 15, that is, in the harness terminals 13. Also, the wire harness 9 is further constituted of multiple fixing members (for example, cramps) (which are not shown) for wiring the wire harness 9 at a given position, and a water stop member (for example, a grommet) (which is not shown).

### <Harness Main Body 15>

In FIGS. 1 to 3, the harness main body 15 is constituted of car inside wiring parts 16, 17, a car outside wiring part 18, and two function enhancement parts 19.

### <Car Inside Wiring Parts 16, 17 & Car Outside Wiring Part 18>

In FIGS. 1 to 3, the car inside wiring part 16 is part of the harness main body 15 to be wired on the engine room 6 side. Also, the car inside wiring part 17 is part of the harness main body 15 to be wired on the car rear part 7 side. Meanwhile, the car outside wiring part 18 is part of the harness main body 15 to be wired through the vehicle underfloor 11. The car inside wiring parts 16, 17 and car outside wiring part 18 are formed in a state where two conductive paths 20 shown in FIG. 4A are arranged side by side.

### <Conductive Path 20>

In FIG. 4A, the conductive path 20 is constituted of a conductive conductor 21, an insulating insulator 22 for covering the conductor 21, a conductive braid 23 provided on the outside of the insulator 22, and an insulating sheath 24 for covering the braid 23.

The conductor 21 is made of copper or copper alloy, or, aluminum or aluminum alloy. In this embodiment, there is employed an aluminum-made conductor (as an example) which has the merit of being inexpensive and lightweight.

In FIGS. 1 to 3 and FIG. 4A, as a conductive path 20 used in the car inside wiring parts 16 and 17, in consideration of connecting workability with respect to the inverter unit 4 and junction block 12, there is employed a conductive path having a conductor structure which is easy to bend. Specifically, there is employed a conductor 21 (stranded conductor) produced by twisting element wires so as to have a circular cross section. The conductive path 20 for the car inside wiring parts 16 and 17 is a so-called electric wire.

Meanwhile, the conductive path 20 used in the car outside wiring part 18 is required to maintain the route condition in the vehicle underfloor 11. Thus, there is employed a conductive path having a shape-retainable conductor structure. Specifically, there is employed a bar-shaped conductor 21 (bar conductor) having a round single core. The conductive path 20 for the car outside wiring part 18 is a so-called bar electric wire. Since the conductive path 20 for the car outside wiring part 18 can maintain the route condition in the vehicle underfloor 11, it provides an effect that the number of fixing members (such as cramps) used for wiring can be reduced.

In FIG. 4A, the insulator 22 is formed as a cover having a circular cross section by extrusion molding thermoplastic resin material on the outer peripheral surface of the conductor 21. The insulator 22 is formed to have a given thickness. As the thermoplastic resin material, there can be used various kinds of well-known materials, for example, it can be selected properly from polymer materials such as PVC, polyethylene resin and polypropylene resin.

In FIG. 4A, the braid 23 is formed, for example, by knitting a very fine metal wire into a tubular shape. The braid 23 is processed so as to be contactable with a shield case (not shown) and shield shells 34 and 41 (to be discussed later). The braid 23 is used as a shield member. Here, the braid 23 is not limitative but metal foil may also be employed.

In FIG. 4A, the sheath 24 is formed as a cover with a circular cross section by extrusion molding thermoplastic resin material on the outside of the braid 23. The sheath 24 is formed to have a given thickness. As the thermoplastic resin material, there can be used various kinds of well-known materials, for example, it can be selected properly from polymer materials such as PVC, polyethylene resin and polypropylene resin.

Here, it is arbitrary whether the sheath 24 is included in the configuration of the conductive path 20 or not. That is, there may also be employed a conductive path 20 the outermost layer of which is constituted of the braid 23.

### <Other Examples of Conductive Path 20>

The conductive path 20 is not limited to FIG. 4A but may also be configured as shown in FIGS. 4B and 4C. A conductive path 20 of FIG. 4B is constituted of a conductive belt-shaped bus bar 25, an insulating insulator 22 for covering the bus bar 25, and a conductive braid 23 arranged on the outside of the insulator 22.

Also, a conductive path 20 of FIG. 4C is constituted of a first conductive conductor 26, a first insulating insulator 27 covering the first conductor 26, a second conductive conductor 28 provided on the outside of the first insulator 27, a second insulating insulator 29 covering the second conductor 28, a conductive braid 23 provided on the outside of the second insulator 29, and an insulating sheath 24 covering the braid 23. The conductive path 20 of FIG. 4C is configured such that the above composing elements are arranged coaxially and, in the JPA Publication 2013-109936, it is called [a high pressure coaxial compound conductive path].

### <Function Enhancement Part 19>

In FIGS. 1 to 3, the function enhancement part 19 on the engine room 6 side is configured such that it can connect together the car inside wiring part 16 and car outside wiring part 18 electrically. Also, the function enhancement part 19 on the car rear part 7 side is configured such that it can connect together the car inside wiring part 17 and car outside wiring part 18 electrically. These two function enhancement parts 19 are respectively formed, for example, such that they are arranged at shown positions where they rise from the vehicle underfloor 11 toward the engine room 6 and car rear part 7, and are fixed by a fixing part 56 (which is discussed later) to the fixing targets of the wiring destinations (the arrangement and number of the function enhancement parts 19 are just an example). The function enhancement parts 19 are employed as parts which are effective when increasing the number of auxiliary devices H1, H2 (devices) to thereby enhance the function as shown from the state of FIG. 1 to the states of FIGS. 2 and 3.

Here, with respect to the function enhancement part 19 on the engine room 6 side, FIG. 1 shows a state before the function is enhanced, and FIGS. 2 and 3 show the state after the function is enhanced.

### <Function Enhancement Part 19 Before Function is Enhanced>

In FIGS. 1, 5A, 5B, 6A, and 6B, the function enhancement parts 19 before function enhancement are formed as structure parts which are disconnected at a given position of the intermediate portion of the harness main body 15 and can be electrically connected together afterward. Specifically, they are formed in the structure parts that can be connected together by a female connector 30 provided on the end (the end of the disconnected portion) of the conductive path 20 for the car inside wiring part 16 and a male connector 31 provided on the end (the end of the disconnected portion) of the conductive path 20 for the car outside wiring part 18. In the function enhancement parts 19 before function enhancement, as shown in FIG. 5A, the female connector 30 and male connector 31 are fitted with each other. Also, as shown in FIG. 5B, electric connection is made between the connectors.

### <Female Connector 30>

In FIGS. 5A, 5B, 6A, and 6B, the female connector 30 is constituted of conductive female terminal fittings 32, an insulating resin-made female connector housing 33, a conductive metal-made shield shell 34 provided on the outside of the female connector housing 33, and a shield connecting member (not shown) used to bring the braid 23 of the conductive path 20 into contact with the shield shell 34.

While working the end of the conductive path 20 for the car inside wiring part 16, the female terminal fittings 32 are formed in such worked portion. The female terminal fittings 32 are formed so as to include a female electric contact part 35 and a conductor contact part 36 arranged continuously with the female electric contact part 35. The female terminal fittings 32 are stored into the female connector housing 33. The female connector housing 33 is formed in a box shape including a fitting projection 37. The fitting projection 37 is formed as a connector fitting portion to be fitted with the male connector 31. The shield shell 34 is used to perform a shield function. In the shield shell 34, there is formed an annular-shaped flange portion 38 serving as a portion contactable with a shield shell 41 (to be discussed later) of the male connector 31.

Here, the female connector 30 has a waterproof function in addition to the shield function (the waterproof function is secured using a packing (not shown) or the like).

### <Male Connector 31>

In FIGS. 5A, 5B, 6A, and 6B, the male connector 31 is constituted of conductive male terminal fittings 39, an insulating resin-made male connector housing 40, a conductive metal-made shield shell 41 provided on the outside of the male connector housing 40, and a shield connecting member (not shown) used to bring the braid 23 of the conductive path 20 into contact with the shield shell 41.

While working the end of the conductive path 20 for the car outside wiring part 18, the male terminal fittings 39 are formed in this worked portion. The male terminal fittings 39 are formed so as to have a male electric contact part 42 and a conductor connection part 43 arranged continuously with the electric contact part 42. The male terminal fittings 39 are stored into the male connector housing 40. The male connector housing 40 is formed in a box shape having a fitting recess 44. The fitting recess 44 is formed as a connector fitting portion contactable with the male connector 30. The shield shell 41 is used to perform a shield function. The end of the shield shell 41 is formed such that the flange portion 38 of the female connector 30 can come into contact therewith to thereby provide a contacted state between them.

Here, the male connector 31 has a waterproof function in addition to the shield function (the waterproof function is secured using a packing (not shown) or the like).

<Function Enhancement Part 19 after Function Enhancement>

In FIGS. 2 and 3, the function enhancement part 19 after function enhancement is formed as a structure part which can increase auxiliary devices H1 and H2 (devices) to thereby enhance the function. Specifically, it is formed as a structure part where one or two function enhancement part main bodies 45 intervene between the female connector 30 and male connector 31. The function enhancement part 19 after function enhancement, as shown in FIG. 10, provides a state where the female connector 30 and male connector 31 are connector fitted with the function enhancement part main body 45. Also, as shown in FIG. 11, within the function enhancement part 19, electric connection is made.

### <Function Enhancement Part Main Body 45>

In FIGS. 7 to 11, the function enhancement part main body 45, which is used when enhancing the function, is constituted of a case body 46, connectors connecting circuits 47, 48 to be stored into the case body 46, branches connecting circuits 49, 50 which are stored into the case body 46 and part of which can be pulled out therefrom.

The function enhancement part main body 45 is formed such that, when two or more function enhancement part main bodies 45 are used, these function enhancement part main bodies 45 can be connected to each other.

### <Case Body 46>

In FIGS. 7 and 9, the case body 46 is formed in a box shape including an insulating resin-made case body resin part 51 and a case body metal part 52 covering the case body resin part 51. The case body metal part 52 is a conductive metal member and has a similar function to a shield shell. In the case body 46, there are arranged a function-enhancement-part-side male connector 53 and a function-enhancement-part-side female connector 54. In the case body 46, there are also arranged a cover part 55 and a fixing part 56. Here, the case body 46 should also have a waterproof function in addition to the shield function (the waterproof function is secured using a packing (not shown) or the like).

### <Function-Enhancement-Part-Side Male Connector 53>

In FIGS. 7, 8 and 10, the function-enhancement-part-side male connector 53 is constituted of a conductive male terminal part 57, an insulating resin-made male connector housing part 58, and a conductive metal-made shield shell part 59 provided on the outside of the male connector housing part 58. The male connector housing part 58 and shield shell part 59 are formed as part of the case body resin part 51 and case body metal part 52, respectively.

The male terminal parts 57 are respectively arranged in the ends of the connectors connecting circuits 47, 48, include male electric contact portions 60, and are stored into the male connector housing part 58. The male connector housing part 58 is formed in a box shape including a fitting recess 61. The fitting recess 61 is formed as a connector fitting part to be fitted with the female connector 30 and a function-enhancement-part-side female connector 54 (to be discussed later). The shield shell part 59 is provided so as to perform the shield function. The end of the shield shell part 59 is formed such that the flange part 38 of the female connector 30 etc. can be contacted therewith to provide a contact state between them.

### <Function-Enhancement-Part-Side Female Connector 54>

In FIGS. 7, 8 and 10, the function-enhancement-part-side female connector 54 is constituted of a conductive female terminal part 62 and an insulating resin-made female connector housing part 63. The female connector housing part 63 is formed as part of the case body resin part 51.

The female terminal parts 62 are respectively arranged in the ends of the connectors connecting circuits 47 and 48, include female electric contact portions 64, and are stored into the female connector housing part 63. The female connector housing part 63 is formed in a box shape including a fitting projection 65. The fitting projection 65 is formed as a connector fitting portion connector-fittable with the male connector 31 and function-enhancement-part-side male connector 53.

### <Cover Part 54>

In FIGS. 7 and 9, the cover part 55 is formed as a part which can face the connectors connecting circuits 47, 48 and branch connecting circuits 49, 50 respectively to be stored within the case body 46, and further an overcurrent blocking part 68 to be discussed later. The cover part 55 has an advantage that, simply by opening it, for example, replacement of the overcurrent blocking part 68 and maintenance of the circuits are possible. Here, two-dot chain lines L1 and L2 of FIG. 7 show the side positions of the cover part 55 when it is closed.

### <Fixing Part 56>

In FIGS. 7 and 9, the fixing part 56 is formed as a part for fixing the wire harness 9 (see FIGS. 2 and 3) to the fixing target (for example, the vehicle underfloor 11) of the wiring destination. In this embodiment, it is formed in a part having such shape as can be fastened and fixed by a bolt and a nut, or by a stud bolt and a nut (none of them shown) (besides this, there can be used such shape as can be fixed by, for example, a bracket). The fixing part 56 has an advantage that, when wiring the wire harness 9, it can fix the wire harness 9 to a fixing target at the position of the function enhancement part 19 (see FIGS. 2 and 3). Also, it has an advantage that it can fix the wire harness 9 even without using an exclusive fixing member. Further, it has an advantage that it can prevent the cover part 55 from unexpectedly opening.

### <Connectors Connecting Circuits 47, 48>

In FIGS. 8 and 9, the connectors connecting circuits 47, 48 are provided as circuits which electrically connect together the function-enhancement-part-side male connector 53 and function-enhancement-part-side female connector 54. In this embodiment, there is employed a belt-shaped bus bar (this is an example and thus, for example, an electric wire may also be employed). The connectors connecting circuits 47, 48 are arranged at a given interval.

### <Branch Connecting Circuits 49, 50>

In FIGS. 8 and 9, the branch connecting circuits 49, 50 are provided for electric connection with connecting wires 66, 66 (see FIG. 10) enhancing from the auxiliary devices H1, H2 (see FIGS. 2 and 3). In this embodiment, there is employed a belt-shaped bus bar (this is just an example). The branch connecting circuits 49, 50 are arranged at a given interval. The branch connecting circuits 49, 50 are formed such that one-side ends thereof can be fixed to the connectors connecting circuits 47, 48 by proper devices and also that the connecting parts 67, 67 thereof on the other end side can be pulled out from the case body 46 in a given length. The branch connecting circuit 50 is formed in a substantially bridge-like shape which straddles the connectors connecting circuit 48. And, the intermediate part of the branch connecting circuit 50 is disconnected, and the overcurrent blocking part 68 is arranged in the disconnected portion.

### <Overcurrent Blocking Part 68>

In FIGS. 8 and 9, the overcurrent blocking part 68 is formed such that it includes a known fuse and a detachable portion capable of detachably attaching this fuse (in this embodiment, it is shown schematically by oblique lines). Such overcurrent blocking part 68 is provided in order to prevent an overcurrent from flowing to the auxiliary devices H1, H2 (see FIGS. 2 and 3).

<Assembly of Function Enhancement Part 19 when Enhancing Function>

In the above configuration and structure, connector fitting engagement between the female connector 30 and male connector 31 is removed as shown in FIGS. 6A and 6B, one or two function enhancement part main bodies 45 are arranged between these female connector 30 and male connector 31 as shown in FIG. 7, and the female connector 30 and male connector 31 are connector fitted with the function enhancement part main body (bodies) 45 as shown in FIGS. 10 and 12, thereby completing assembly of the function enhancement part 19. On completing assembly, within the function enhancement part 19, there is provided a state where electric connection is made as shown in FIG. 11 and, after then, the connecting wires 66, 66 are connected to the connecting parts 67, 67, thereby completing connection to the auxiliary devices H1, H2 (see FIGS. 2 and 3).

Here, in FIG. 12, connection to the auxiliary devices H1, H2 (see FIGS. 2 and 3) is made from the same direction but this is not limitative. That is, in the case that the function enhancement main body 45 is formed in such a manner that the pull-out directions of the branch connecting circuits 49, 50 (the pull-out directions of the connecting parts 67, 67) are set in two different directions with respect to the length direction of the conductive path 20, of course, the auxiliary devices H1, H2 can be connected from the left and right of the conductive path 20. This case provides an advantage that workability related to connection can be enhanced and misconnection can be prevented.

### <Modification of Function Enhancement Part Main Body 45>

A function enhancement part main body 45 shown in FIG. 13 is a modification in which the part thereof to be connected to the auxiliary devices H1, H2 (see FIGS. 2 and 3), that is, the part where the connecting parts 67, 67 are formed are modified, thereby forming a male connector 69. FIG. 13 shows a modification in which connection of the main body 45 to the auxiliary devices H1, H2 can be made by connectors.

### <Another Modification>

FIG. 14 shows a modification in which a shield function is given using a cylindrical braid 70 and the above-mentioned shield shell is not used. The braid 70 is produced by knitting an extremely fine conductive metal wire, in which, of course, when the meshes of the arrows A, B parts are expanded, fixation by the fixing part 56 and pull-out of an electric wire are possible.

As has been described heretofore with reference to FIGS. 1 to 14, according to the one or more embodiments, the intermediate portions of the conductive path 20 are disconnected and the disconnected portions are electrically connected together to form the function enhancement parts 19. Thus, the invention provides an effect that, by using the function enhancement parts 19, the auxiliary device H1 (another device) can be connected and the auxiliary device H2 (still another device) can be connected newly and additionally afterward.

Also, according to the one or more embodiments, when trying to connect the auxiliary device H1, or, when trying to connect the auxiliary device H2 newly and additionally afterward, there is eliminated the need to make the conductive path 20 as if it makes U turn from the position of the harness terminal 13. Consequently, the invention provides an effect that the wire harness 9 can be provided using the conductive path 20 with minimum length required; and thus, another effect that, with regard to connection with the auxiliary devices H1, H2, workability can be enhanced, thereby enabling cost reduction.

In the above description, the one or more embodiments are applied to the high voltage wire harness 9 of the hybrid car 1. However, this is not limitative but the invention may also be applied to a low voltage wire harness.

[Description of Reference Numerals and Signs]

| | |
|---|---|
| 1: Hybrid car | 2: Engine 3: Motor unit |
| 4: Inverter unit (device) | 5: Battery 6: Engine room |
| 7: Car rear part | 8, 9: Wire harness |
| 10: Intermediate portion | 11: Vehicle underfloor |
| 12: Junction block (device) | 13: Harness terminal |
| 14: Shield connector | 15: Harness main body |
| 16, 17: Car inside wiring part | |
| 18: Car outside wiring part | |
| 19: Function enhancement part | 20: Conductive path |
| 21: Conductor (stranded conductor, | |
| bar conductor) | |
| 22: Insulator 23: Braid | 24: Sheath 25: Bus bar |
| 26: First conductor (conductor) | |
| 27: First insulator (insulator) | |
| 28: Second conductor (conductor) | |
| 29: Second insulator (insulator) | 30: Female connector |
| 31: Male connector | 32: Female terminal fittings |
| 33: Female connector housing | 34: Shield shell |
| 35: Electric contact part | 36: Conductor connecting part |
| 37: Fitting projection | 38: Flange part |
| 39: Male terminal fittings | 40: Male connector housing |
| 41: Shield shell | 42: Electric contact part |
| 43: Conductor connecting part | 44: Fitting recess |
| 45: Function enhancement part | 46: Case body |
| main body | |
| 47, 48: Connectors connecting | |
| circuit | |
| 49, 50: Branch connecting circuit | 51: Case body resin part |
| 52: Case body metal part | |
| 53: Function-enhancement-part- | |
| side male connector | |
| 54: Function-enhancement-part- | |
| side female connector | |
| 55: Cover part | 56: Fixing part 57: Male terminal part |
| 58: Male connector housing part | 59: Shield shell part |
| 60: Electric contact part | 61: Fitting recess |
| 62: Female terminal part | |
| 63: Female connector housing | 64: Electric contact part |
| part | |
| 65: Fitting projection | 66: Connecting line |
| 67: Connecting part | 68: Overcurrent blocking portion |
| 69: Male connector | 70: Braid |
| H1, H2: Auxiliary device (another | |
| device) | |

What is claimed is:

1. A wire harness comprising:
a conductive path for electrically connecting devices to each other; and
a function enhancement part, in which one or multiple locations of an intermediate portion of the conductive path are disconnected, and disconnected portions of the conductive path are electrically connected to each other so as to enhance a function,
wherein the function enhancement part, in a state before the function is enhanced, is formed in a structure part in which a male connector provided on one end of a disconnected position of the conductive path and a female connector provided on the other end of the disconnected positions of the conductive path are connected together,
wherein the function enhancement part, in a state that the function is enhanced, is formed in a structure part in which one or multiple function enhancement part main bodies are arranged between the male connector and the female connector,
wherein the function enhancement part main body includes a function-enhancement-part-side female connector connectable to the male connector, a function-enhancement-part-side male connector connectable to the female connector, a connectors connecting circuit which connects together the function-enhancement-part-side female connector and the function-enhancement-part-side male connector, and a branch connecting circuit to be connected to the connectors connecting circuit, and
wherein the function-enhancement-part-side female connector and the function-enhancement-part-side male connector of the function enhancement part main bodies which are adjacent, are connectable to each other.

2. A wire harness according to claim 1, wherein an overcurrent blocking part which blocks an overcurrent is provided in the branch connecting circuit.

3. A wire harness according to claim 2, wherein the function enhancement part main body includes a case body in which the connectors connecting circuit and the overcurrent blocking part are stored, and wherein the overcurrent blocking part is drawn out to outside from the case body, and
wherein the case body includes a cover part facing the connectors connecting circuit and the overcurrent blocking part.

4. A wire harness according to claim 3, wherein when a plurality of the function enhancement part main body are arranged in the function enhancement part, the branch connecting circuit can be drawn out in two different directions with respect to the length direction of the conductive path.

5. A wire harness according to claim 1, wherein the function enhancement part main body includes a fixing part which fixes the wire harness to a fixing target of a wiring destination.

6. A wire harness according to claim 1, wherein the function enhancement part includes a structure part having a shield function or a waterproof function.

7. A wire harness according to claim 1, wherein, the conductive path includes any one or a combination of a conductive path having a stranded conductor, a conductive path having a bar conductor, a conductive path having a bus bar, and a conductive path with multiple conductors and insulators arranged coaxially,
wherein the combination includes different type conductive paths which are different at least before and behind the function enhancement part.
